(19) United States
(12) Patent Application Publication
(10) Pub. No.: US 2018/0086268 A1
(43) Pub. Date: Mar. 29, 2018

(54) VEHICLE PERIPHERY IMAGING/DISPLAY DEVICE AND A COMPUTER-READABLE RECORDING MEDIUM

(71) Applicant: TOYOTA JIDOSHA KABUSHIKI KAISHA, Toyota-shi (JP)

(72) Inventor: Takumi KOCHIYA, Nisshin-shi (JP)

(73) Assignee: TOYOTA JIDOSHA KABUSHIKI KAISHA, Toyota-shi (JP)

(21) Appl. No.: 15/700,778

(22) Filed: Sep. 11, 2017

(30) Foreign Application Priority Data
Sep. 23, 2016 (JP) 2016-185507

(51) Int. Cl. B60R 1/04; B60R 1/00; H04N 7/18; H04N 5/232

(52) U.S. Cl. CPC B60R 1/04; B60R 1/006; B60R 2300/105; H04N 5/23293; H04N 7/181

(57) ABSTRACT

In a case in which an ignition switch is turned off, imaging by a camera and display of a monitor are continued for a predetermined time, and thereafter, display of the monitor is stopped. Next, when opening of a door is detected by a courtesy switch, in a case in which display of the monitor is stopped, control is carried out to restart the display and enable confirmation of the vehicle periphery. Further, the display of the monitor is stopped in a case in which closing of a door is detected by a courtesy switch and locking is sensed by a door lock.

### CROSS-REFERENCE TO RELATED APPLICATION

This application is based on and claims priority under 35 USC 119 from Japanese Patent Application No. 2016-185507 filed on Sep. 23, 2016, the disclosure of which is incorporated by reference herein.

### BACKGROUND

### Technical Field

The present disclosure relates to a vehicle periphery imaging/display device and a computer-readable recording medium storing vehicle periphery imaging/display program that display captured images in which the periphery of a vehicle is captured.

### Related Art

There are known vehicle periphery imaging/display devices that capture the periphery of a vehicle by an imaging portion such as a camera or the like and display the captured images obtained by the capturing on a display portion such as a monitor or the like, and thereby allow a vehicle occupant to confirm the periphery of the vehicle instead of by using an optical mirror.

For example, in Patent Document 1 (Japanese Patent Application Laid-Open (JP-A) No. 2016-124391), the device has an imaging portion that is provided at at least one of the left and right side surfaces of the vehicle and captures images of the rear side of the vehicle, and a display portion that displays the images captured by the imaging portion or images that have been generated by subjecting these images to predetermined transformations. The display portion displays images corresponding to differing imaging ranges in a case in which the shift position of the vehicle is the forward position, and in a case in which the shift position is the reverse position, and in a case in which the shift position is the reverse position and a predetermined condition is met.

However, in Patent Document 1, when the ignition switch of the vehicle is turned off, the display of the display portion also is turned off, and therefore, a vehicle occupant cannot confirm the periphery of the vehicle at the time of exiting the vehicle. On the other hand, if display is continued even if the ignition switch is turned off, there is the concern that the battery will be consumed and the battery will go dead, and there is therefore room for improvement.

### SUMMARY

The present disclosure was made in view of the above-described circumstances, and an object thereof is to provide a vehicle periphery imaging/display device and a computer-readable recording medium storing a vehicle periphery imaging/display program that enable confirmation of the periphery of a vehicle at the time when a vehicle occupant exits the vehicle, while suppressing electric power consumption.

A first aspect of the present invention includes: an imaging portion that captures images of a vehicle periphery; a display portion that displays images captured by an imaging portion; and a controller that carries out a processing, the processing including: if an ignition switch is turned off, continuing display of the display portion for a predetermined time and, thereafter, stopping the display; at a time when opening of a door is detected by a detector that detects opening of a door, restarting the display of the display portion if the display of the display portion is stopped; and stopping the display of the display portion in at least one of a case in which closing of a door is detected by the detector or a case in which locking of a door is sensed by a sensor that detects locking of a door.

In accordance with the first aspect, captured images, which are obtained by imaging by the imaging portion that captures images of the vehicle periphery, are displayed at the display portion.

The controller caries out display control that includes a processing that, in a case in which an ignition switch is turned off, continues the display of the display portion for a predetermined time and, thereafter, stops the display, and a processing that, at a time when opening of a door is detected by a detecting portion that detects opening of a door, restarts the display of the display portion in a case in which the display of the display portion is stopped, and a processing that stops the display of the display portion in at least one of a case in which closing of a door is detected by the detecting portion and a case in which locking of a door is sensed by a sensing portion that senses locking of a door.

Namely, during a predetermined time from the turning-off of the ignition switch, the captured images of the vehicle periphery are displayed on the display portion. Therefore, a vehicle occupant can confirm the vehicle periphery at the time of exiting the vehicle. Further, after a predetermined time elapses, the display is stopped, and therefore, the amount of electric power that is consumed can be reduced.

Further even if the display is stopped, in a case in which opening of the door is detected, the display is restarted, and the vehicle occupant can confirm the vehicle periphery at the time of exiting the vehicle. Further, in a case in which at least one of closing and locking of a door is carried out, the display is stopped, and therefore, the amount of electric power that is consumed can be reduced.

Accordingly, due to control of the controller being carried out, a vehicle occupant can confirm the periphery of the vehicle at the time of exiting the vehicle, while the amount of electric power that is consumed is suppressed.

Note that, as in a second aspect, wherein the processing may further include, if the restarting of the display is carried out, continuing, for a predetermined restart time, restarting of the display of the display portion, and thereafter, stopping the display. Due thereto, the amount of electric power, which would be consumed due to the display being continued indefinitely after the display is restarted, can be reduced.

Further, as in a third aspect, there may be a form in which the imaging portion captures images of a vehicle rear side, and the display portion is provided at an upper portion of a vehicle front side of a vehicle cabin interior and functions as an inner rearview mirror. Namely, at the time of exiting the vehicle, due to a vehicle occupant confirming the display portion that functions as the inner rearview mirror, the vehicle occupant can safely confirm the region at the rear of the vehicle.

Further, as in a fourth aspect, there may be a form in which the imaging portions are provided respectively at a left and a right of a vehicle and capture images of a vehicle rear side, and the display portions are provided respectively at the left and the right of the vehicle in correspondence with the imaging portions and function as door mirrors. Namely, at the time of exiting the vehicle, due to a vehicle occupant confirming the display portion that functions as a door mirror, the vehicle occupant can safely confirm the region at the rear side of the vehicle.

Further, as in a fifth aspect, there may be a vehicle periphery imaging/display program for causing a computer to perform the processing according to any one of the above-described vehicle periphery imaging/display devices.

As described above, in accordance with the present disclosure, there is the effect that, at the time of exiting the vehicle, a vehicle occupant can confirm the periphery of the vehicle, while the amount of electric power that is consumed is suppressed.

### BRIEF DESCRIPTION OF THE DRAWINGS

FIG. 1 is a drawing showing an approximate vehicle mounting position of a vehicle periphery imaging/display device relating to the present embodiment;

FIG. 2 is a block view showing the schematic structure of the vehicle periphery imaging/display device relating to the present embodiment;

FIG. 3 is a flowchart showing an example of the flow of vehicle exiting display control that is carried out at a control device of the vehicle periphery imaging/display device relating to the present embodiment;

FIG. 4 is a flowchart showing an example of a modified example of the flow of the vehicle exiting display control that is carried out at the control device of the vehicle periphery imaging/display device relating to the present embodiment;

FIG. 5 is a drawing showing an approximate vehicle mounting position of a modified example of the vehicle periphery imaging/display device relating to the present embodiment; and

FIG. 6 is a block diagram showing the schematic structure of the modified example of the vehicle periphery imaging/display device relating to the present embodiment.

### DETAILED DESCRIPTION

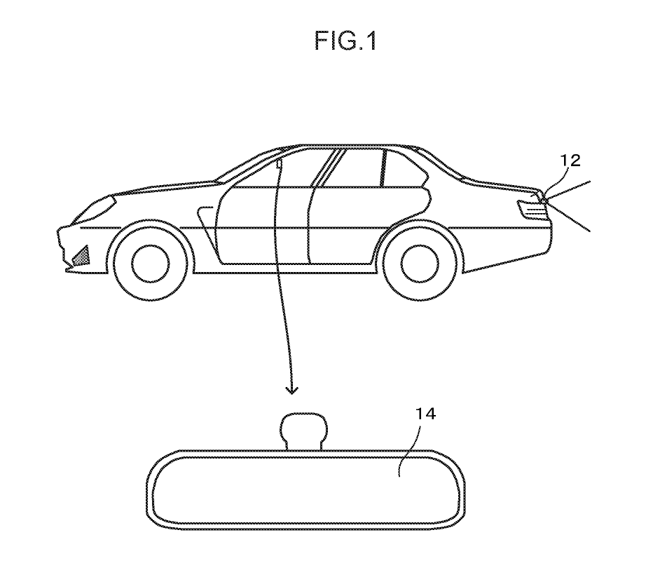

An example of an embodiment of the present disclosure is described in detail hereinafter with reference to the drawings. FIG. 1 is a drawing showing an approximate vehicle mounting position of a vehicle periphery imaging/display device relating to the present embodiment.

At the vehicle periphery imaging/display device relating to the present embodiment, imaging is carried out by a camera 12 that serves as an example of an imaging portion and that is provided at the rear of the vehicle. Captured images, which are obtained by imaging by the camera 12, are displayed on a monitor 14 that serves as an example of a display portion and is provided at the position of the inner rearview mirror that is within the vehicle cabin. The monitor 14 can be made to function as the inner rearview mirror by providing the monitor 14 at the position of the inner rearview mirror.

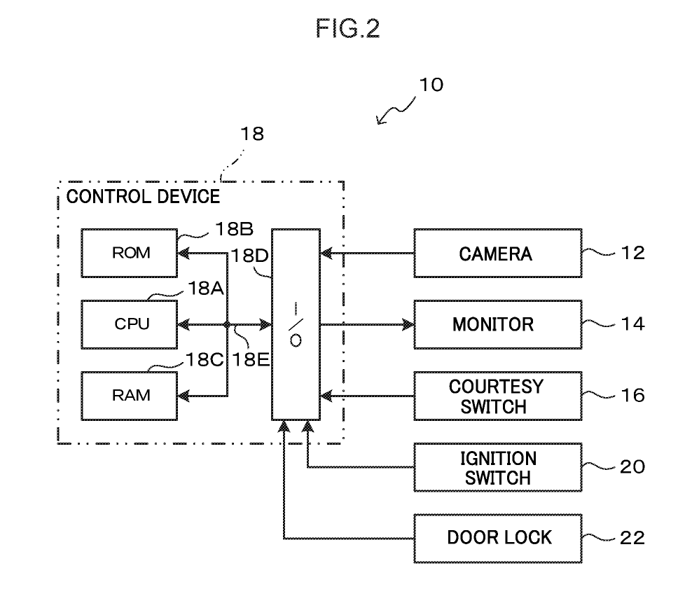

FIG. 2 is a block diagram showing the schematic structure of a vehicle periphery imaging/display device 10 relating to the present embodiment.

The vehicle periphery imaging/display device 10 relating to the present embodiment has the camera 12, the monitor 14, courtesy switches 16 that serve as examples of a detecting portion, an ignition switch 20, a door lock 22 that serves as an example of a sensing portion, and a control device 18 that serves as an example of a controller.

The camera 12 captures images of the rear of the vehicle, and outputs the results of imaging to the control device 18. The camera 12 is disposed at the vehicle exterior (e.g., the trunk or the like) for example, and captures images of the region at the rear of the vehicle as the vehicle periphery. Note that, in the present embodiment, an example of providing the camera 12 at the exterior of the vehicle is described, but the camera may be provided within the vehicle cabin.

The monitor 14 is provided at the position where the inner rearview mirror is generally disposed, and is connected to the control device 18. Concretely, a position at the vehicle front side of the vehicle transverse direction center of the ceiling, a vicinity of the upper portion of the center of the front windshield glass, and the like are examples of the position at which the inner rearview mirror is generally disposed. The captured images that are captured by the camera 12 are displayed on the monitor 14 by control of the control device 18.

The courtesy switches 16 are switches for detecting opening/closure of the respective doors that are provided at the vehicle. On/off signals of the respective courtesy switches 16 are inputted to the control device 18 as signal expressing opening/closure of the doors. The courtesy switches 16 are provided in respective correspondence with the doors, but a single one thereof is illustrated representatively in FIG. 1.

The ignition switch 20 is a switch for starting-up the vehicle and for turning on/off the supply of power to the in-vehicle devices. On/off signals of the ignition switch 20 are inputted to the control device 18.

The door lock 22 is a mechanism that carries out unlocking and locking of the door locks provided at the vehicle. Signals, which express unlocking and locking, of the door lock 22 are inputted to the control device 18.

The control device 18 is structured by a microcomputer in which a CPU 18A, a ROM 18B, a RAM 18C and an I/O (input/output interface) 18D are respectively connected to a bus 18E.

Various types of programs, such as a vehicle viewing control program for carrying out display control for displaying on the monitor 14 the captured images that are captured by the camera 12, and the like are stored in the ROM 18B. Control of the display on the monitor 14 is carried out due to the programs that are stored in the ROM 18B being expanded in the RAM 18C and being executed by the CPU 18A.

The camera 12, the monitor 14, the courtesy switches 16, the ignition switch 20 and the door lock 22 are respectively connected to the I/O 18D. The control device 18 acquires the results of imaging of the camera 12, and carries out, on the captured images, processings for displaying the captured images on the monitor 14, and displays the captured images on the monitor 14.

At the vehicle periphery imaging/display device 10 relating to the present embodiment, because the captured images that are captured by the camera 12 are displayed on the monitor 14, when the ignition switch 10 is turned off, the monitor 14 also stops, and confirmation of the periphery of the vehicle at the time of exiting of the vehicle can no longer be carried out.

Thus, the control device 18 of the vehicle periphery imaging/display device 10 relating to the present embodiment carries out vehicle exiting display control for making it possible for a vehicle occupant to confirm the periphery of the vehicle at the time of exiting the vehicle. Concretely, in case in which the ignition switch 20 is turned off, the vehicle exiting display control continues the imaging by the camera 12 and the display on the monitor 14 for a predetermined time, and thereafter, stops the display on the monitor 14. Then, at the time when opening of a door is detected by the courtesy switch 16, in a case in which the display of the monitor 14 is stopped, the vehicle exiting display control carries out control so as to restart the display and make it possible to confirm the periphery of the vehicle. Further, in a case in which closing of the door is detected by the courtesy switch 16 and locking is sensed by the door lock 22, the vehicle exiting display control stops the display of the monitor 14. By carrying out the vehicle exiting display control in this way, captured images of the periphery of the vehicle can be displayed on the monitor 14 at the time when a vehicle occupant exits the vehicle, and the periphery of the vehicle can be confirmed.

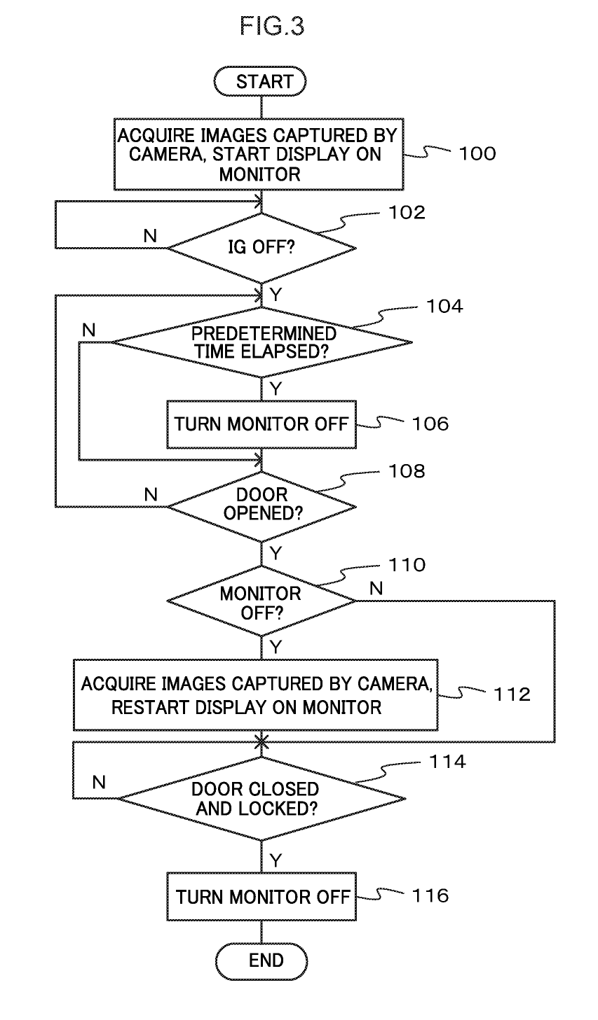

An example of a flow of concrete processings that are carried out at the control device 18 of the vehicle periphery imaging/display device 10, which relates to the present embodiment and is structured as described above, is described next. FIG. 3 is a flowchart showing an example of the flow of the vehicle exiting display control that is carried out at the control device 18 of the vehicle periphery imaging/display device 10 relating to the present embodiment.

In step 100, the CPU 18A acquires the captured images of the camera 12 and starts display of the captured images on the monitor 14, and the routine moves on to step 102.

In step 102, the CPU 18A judges whether or not the ignition switch (IG) 20 has been turned off. The routine stands-by until this judgment is affirmative, and then moves on to step 104.

In step 104, the CPU 18A judges whether or not a predetermined time has elapsed from the ignition switch 20 being turned off If this judgment is affirmative, the routine moves on to step 106, and, if this judgment is negative, the routine moves on to step 108.

In step 106, the CPU 18A turns the monitor 14 off and stops the display of the monitor 14, and the routine moves on to step 108. Namely, during a predetermined time period from the turning-off of the ignition switch 20, the images captured by the camera 12 are displayed on the monitor 14, and a vehicle occupant can confirm the rear of the vehicle in order to exit the vehicle. Note that the camera 12 also may be turned off together with the turning-off of the monitor 14, but, in order to be able to restart the imaging and immediately display the images at the time when a vehicle occupant exits the vehicle, the imaging by the camera 12 may be continued.

In step 108, on the basis of the signals from the courtesy switches 16, the CPU 18A judges whether or not a door has been opened. If this judgment is affirmative, the routine moves on to step 110, and, if this judgment is negative, the routine returns to step 104, and the above-described processings are repeated.

In step 110, the CPU 18A judges whether or not the monitor 14 is off. Namely, the CPU 18A judges whether or not a predetermined time has elapsed from the turning-off of the ignition switch 20, and the monitor 14 is off. If this judgment is affirmative, the routine moves on to step 112, and, if this judgment is negative, the routine moves on to step 114.

In step 112, the CPU 18A acquires the images captured by the camera 12, and restarts display of the captured images on the monitor 14, and the routine moves on to step 114.

In step 114, on the basis of the signals from the courtesy switches 16 and the door lock 22, the CPU 18A judges whether or not a door has been closed and locked. The routine stands-by until the judgment becomes affirmative, and then moves on to step 116. Note that it may only be judged whether or not a door has been closed, or it may only be judged whether or not a door has been locked.

In step 116, the CPU 18A turns the monitor 14 off and stops the display of the monitor 14, and ends the series of processings. Note that the camera 12 as well may be turned off together with the turning-off of the monitor 14, but, considering that the vehicle occupant may get back into the vehicle immediately after exiting the vehicle, the camera 12 may be turned off after a predetermined time has elapsed from the turning-off of the monitor 14.

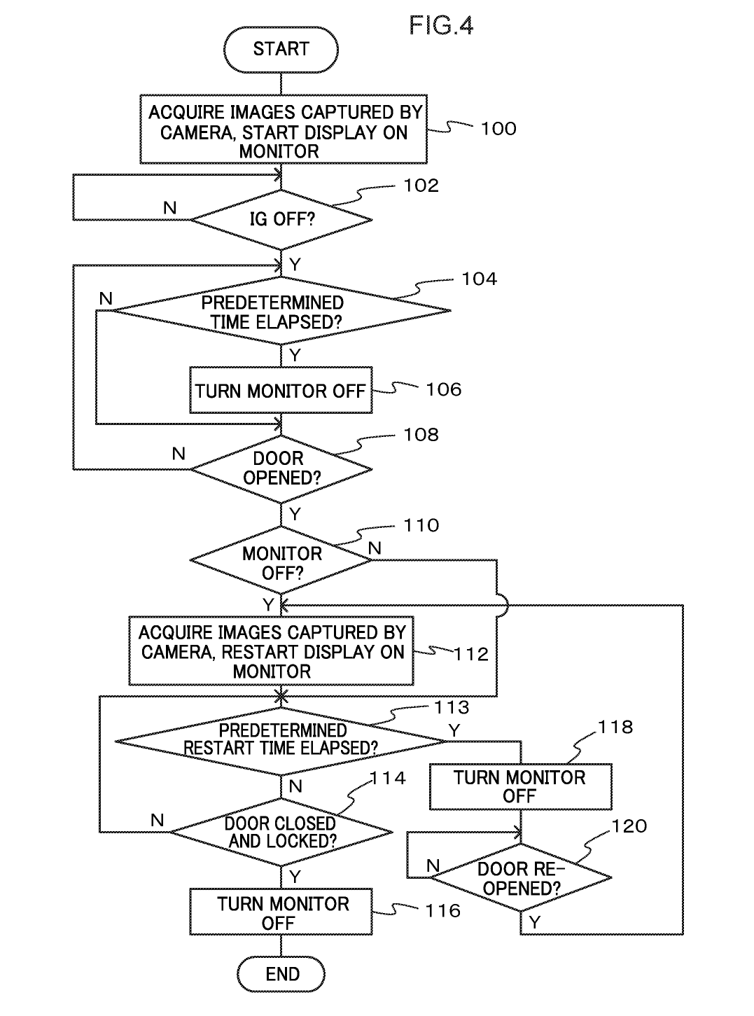

Note that, as shown in FIG. 4, steps 113, 118, 120 may be added to the processing of FIG. 3. Namely, after display of the monitor 14 is restarted in step 112, the routine moves on to step 113, and, in step 113, the CPU 18A judges whether or not a predetermined restart time has elapsed. If this judgment is negative, the routine moves on to step 114, and, if this judgment is affirmative, the routine moves on to step 118 where the CPU 18 turns the monitor 14 off, and the routine moves on to step 120. In step 120, on the basis of the signals from the courtesy switches 16, the CPU 18A judges whether or not a door has been re-opened. The routine stands-by until the judgment is affirmative, and then moves on to step 112. The restart time in this case may be the same as the predetermined time of step 104, or may be different therefrom.

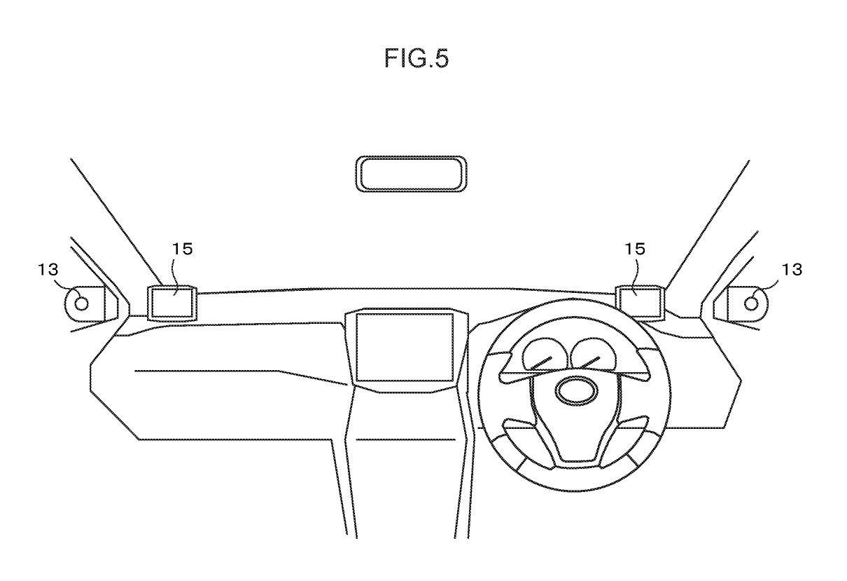

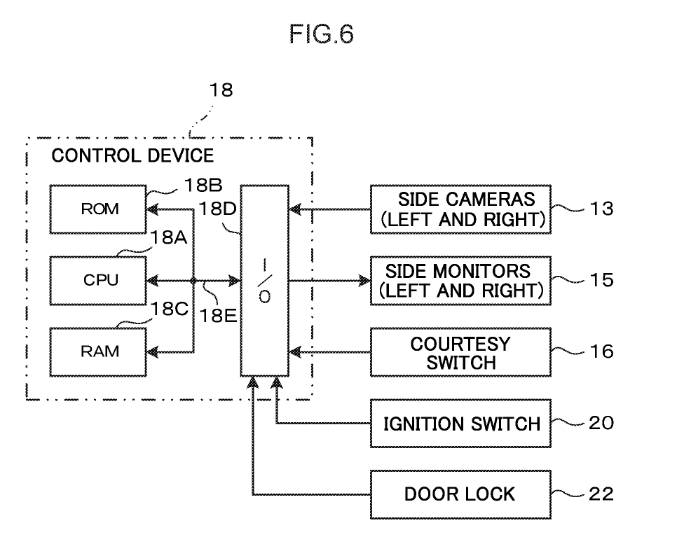

Further, the above embodiment describes an example in which the monitor 14 is made to function as an inner rearview mirror, but the present invention is not limited to this. For example the monitor may be made to function as a door mirror. Concretely, as shown in FIG. 5, rear cameras 13 that capture images of the region at the vehicle rear side are set at the outer sides of the vehicle front side ends of the vertical direction intermediate portions of the left and right side doors (unillustrated front side doors) of the vehicle. Note that there may be a form in which the side cameras 13 are mounted not to the side doors, but to another position such as the front fender or the like. Further, side monitors 15, which display the captured images obtained by imaging by the side cameras 13, are provided so as to correspond to the left and right side cameras 13, respectively. The region at the vehicle rear side, which serves as the periphery of the vehicle, can be seen by providing the side monitors 15 at, for example, vicinities of the lower ends of the front pillars, and using them instead of the door mirrors, and confirming the monitor 14. Further, as shown in FIG. 6, instead of the camera 12 and the monitor 14 of the above-described embodiment, the side cameras 13 and the side monitors 15 are connected to the I/O 18D of the control device 18, and the vehicle exiting display control is carried out in the same way as in the above-described embodiment. Namely, up until a predetermined time elapses from the turning-off of the ignition switch 20, the captured images that are captured by the side cameras 13 are displayed on the side monitors 15, and the vehicle occupant can confirm the vehicle rear side at the time of exiting the vehicle. Further, after a predetermined time elapses from the turning-off of the ignition switch 20, the side monitors 15 are turned off, and a reduction in the amount of electric power that is consumed is devised. Further, thereafter, in a case in which a door is opened, display of the side monitors 15 is restarted, and the vehicle occupant can confirm the region at the rear of the vehicle at the time of exiting the vehicle. Due thereto, even if the side monitors 15 are turned off, by opening a door a little, display is restarted and confirmation of the vehicle rear side becomes possible. Further, the side monitors 15 are turned off just after the door is closed and locked. Note that the camera 12, the monitor 14, the side cameras 13 and the side monitors 15 may all be provided, and the vehicle exiting display control may be carried out in the same way as described above. Further, the placement of the monitor 14 is not limited to the position of the inner rearview mirror or to a position corresponding to a door mirror, and the monitor may be provided at another position such as at the central portion of the instrument panel, or the like. Further, the positions of the camera 12 and the side cameras 13 as well are not limited to the above-described positions, and it suffices for them to be positions at which images of the periphery of the vehicle can be captured.

Further, description has been given of a case in which the vehicle exiting display control, which is shown in FIG. 3 and is carried out at the control device 18 of the vehicle periphery imaging/display device 10 of the above-described embodiment, is made to be a software processing that is carried out by the execution of a program, but may be a processing that is carried out by hardware. Or, the vehicle exiting display control may be a processing that combines both software and hardware. Further, the program that is stored in the ROM may be stored on any of various types of storage media and distributed.

Moreover, the present disclosure is not limited to the above, and, other than the above, can of course be implemented by being modified in various ways within a scope that does not depart from the gist thereof.

What is claimed is:

1. A vehicle periphery imaging/display device comprising:
an imaging portion that captures images of a vehicle periphery;
a display portion that displays images captured by an imaging portion; and
a controller that carries out a processing, the processing including:
if an ignition switch is turned off, continuing display of the display portion for a predetermined time and, thereafter, stopping the display;
at a time when opening of a door is detected by a detector that detects opening of a door, restarting the display of the display portion if the display of the display portion is stopped; and
stopping the display of the display portion in at least one of a case in which closing of a door is detected by the detecting portion or a case in which locking of a door is sensed by a sensor that detects locking of a door.

2. The vehicle periphery imaging/display device of claim 1, wherein the processing further includes, if the restarting of the display is carried out, continuing, for a predetermined restart time, restarting of the display of the display portion, and thereafter, stopping the display.

3. The vehicle periphery imaging/display device of claim 1, wherein the imaging portion captures images of a vehicle rear side, and the display portion is provided at an upper portion of a vehicle front side of a vehicle cabin interior and functions as an inner rearview mirror.

4. The vehicle periphery imaging/display device of claim 2, wherein the imaging portion captures images of a vehicle rear side, and the display portion is provided at an upper portion of a vehicle front side of a vehicle cabin interior and functions as an inner rearview mirror.

5. The vehicle periphery imaging/display device of claim 1, wherein the imaging portions are provided respectively at a left and a right of a vehicle and capture images of a vehicle rear side, and the display portions are provided respectively at the left and the right of the vehicle in correspondence with the imaging portions and function as door mirrors.

6. The vehicle periphery imaging/display device of claim 2, wherein the imaging portions are provided respectively at a left and a right of a vehicle and capture images of a vehicle rear side, and the display portions are provided respectively at the left and the right of the vehicle in correspondence with the imaging portions and function as door mirrors.

7. A non-transitory computer-readable recording medium storing a vehicle periphery imaging/display program for causing a computer to perform a display control processing for a display portion, the display portion displaying images obtained by an imaging portion that captures images of a vehicle periphery,
the display control processing including:
if an ignition switch is turned off, continuing display of the display portion for a predetermined time and, thereafter, stopping the display;
at a time when opening of a door is detected by a detector that detects opening of a door, restarting the display of the display portion if the display of the display portion is stopped; and
stopping the display of the display portion in at least one of a case in which closing of a door is detected by the detector or a case in which locking of a door is sensed by a sensor that detects locking of a door.

8. The computer-readable recording medium of claim 7, wherein the display control processing further includes, if the restarting of the display is carried out, continuing, for a predetermined restart time, restarting of the display of the display portion, and thereafter, stopping the display.

9. The computer-readable recording medium of claim 7, wherein the imaging portion captures images of a vehicle rear side, and the display portion is provided at an upper portion of a vehicle front side of a vehicle cabin interior and functions as an inner rearview mirror.

10. The computer-readable recording medium of claim 8, wherein the imaging portion captures images of a vehicle rear side, and the display portion is provided at an upper portion of a vehicle front side of a vehicle cabin interior and functions as an inner rearview mirror.

11. The computer-readable recording medium of claim 7, wherein the imaging portions are provided respectively at a left and a right of a vehicle and capture images of a vehicle rear side, and the display portions are provided respectively at the left and the right of the vehicle in correspondence with the imaging portions and function as door mirrors.

12. The computer-readable recording medium of claim 8, wherein the imaging portions are provided respectively at a left and a right of a vehicle and capture images of a vehicle rear side, and the display portions are provided respectively at the left and the right of the vehicle in correspondence with the imaging portions and function as door mirrors.
